(19) United States
(12) Patent Application Publication
(10) Pub. No.: US 2026/0196732 A1
(43) Pub. Date: Jul. 9, 2026

(54) ELECTRONIC DEVICE

(71) Applicant: Advanced Semiconductor Engineering, Inc., Kaohsiung (TW)

(72) Inventors: Cheng-Yu WU, Kaohsiung (TW); Hung-Hsiang CHENG, Kaohsiung (TW); Ching-Fang LIN, Kaohsiung (TW); Ken-Huang LIN, Kaohsiung (TW); Ming-Lung KUNG, Kaohsiung (TW)

(73) Assignee: Advanced Semiconductor Engineering, Inc., Kaohsiung (TW)

(21) Appl. No.: 19/011,564

(22) Filed: Jan. 6, 2025

(51) Int. Cl. H01Q 9/18; H01Q 9/04; H01Q 21/24

(52) U.S. Cl. CPC H01Q 9/18; H01Q 9/0407; H01Q 21/24

(57) ABSTRACT

The present disclosure relates to an electronic device. The electronic device includes a magneto-electric dipole antenna and a first conductive column adjacent to and spaced apart from the magneto-electric dipole antenna. The first conductive column is configured to adjust a mode of the electrical field of the magneto-electric dipole antenna.

### BACKGROUND

### 1. Technical Field

The present disclosure generally relates to an electronic device, and more particularly to an electronic device including a magneto-electric dipole antenna and a shorting pin.

### 2. Description of the Related Art

The present 5G antennas generally require coverage of multiple frequency bands (especially FR2), compact size, and thin profile, requiring support for dual bands and dual polarization. In present practice, magneto-electric (ME) dipole antennas are employed to overcome bandwidth limitations, providing complementary characteristics and ultra-wideband performance. However, the antenna thickness may have difficulty to be reduced due to the magnetic dipole. Thus, currently used dual-polarized magneto-electric dipole (dual-pole) antennas cannot simultaneously achieve wide bandwidth, thin thickness, and full target frequency band coverage. Therefore, an improved electronic device is called for.

### SUMMARY

In some embodiments, an electronic device includes a magneto-electric dipole antenna and a first conductive column adjacent to and spaced apart from the magneto-electric dipole antenna. The first conductive column is configured to adjust a mode of the electrical field of the magneto-electric dipole antenna.

In some embodiments, an electronic device includes an antenna, a feeding element, and a conductive column. The feeding element extends along a first direction and electrically coupled to the antenna, such that the antenna is configured to radiate signals. The conductive column is substantially aligned with the feeding element in the first direction and connected to the ground.

In some embodiments, an electronic device includes a dual polarized antenna, a first feeding element, a second feeding element, and a first conductive column. The first feeding element extends in a first direction. The second feeding element extends across the first feeding element in a second direction substantially perpendicular to the first direction. The first conductive column is adjacent to and spaced apart from the first feeding element. The first conductive column is configured to adjust a direction of the electrical field of the dual polarized antenna under operating.

### BRIEF DESCRIPTION OF THE DRAWINGS

Aspects of the present disclosure are readily understood from the following detailed description when read with the accompanying figures. It should be noted that various features may not be drawn to scale. The dimensions of the various features may be arbitrarily increased or reduced for clarity of discussion.

FIG. 1A is a schematic diagram of an electronic device, in accordance with some embodiments of the present disclosure.

FIG. 1B is a top view of an electronic device, in accordance with some embodiments of the present disclosure.

FIG. 1C is a cross-section of an electronic device along line A-A of FIG. 1B, in accordance with some embodiments of the present disclosure.

FIG. 1D is a cross-section of an electronic device along line B-B of FIG. 1B, in accordance with some embodiments of the present disclosure.

FIG. 1E is a cross-section of an electronic device along line C-C of FIG. 1B, in accordance with some embodiments of the present disclosure.

FIG. 2 is a graph illustrating frequency versus impedance of an electronic device, in accordance with some embodiments of the present disclosure.

FIG. 3 is a graph illustrating frequency versus impedance of an electronic device, in accordance with some embodiments of the present disclosure.

FIG. 4A is a graph illustrating electrical field distribution of an electronic device under a higher order mode, in accordance with some embodiments of the present disclosure.

FIG. 4B is a graph illustrating electrical field distribution of an electronic device under a fundamental mode, in accordance with some embodiments of the present disclosure.

FIGS. 5A, 5B, 5C, 5D, and 5E are schematic diagrams illustrating an electrical field of an antenna, in accordance with some embodiments of the present disclosure.

FIG. 6 is a graph illustrating frequency versus return loss of an electronic device, in accordance with some embodiments of the present disclosure.

FIG. 7 is a graph illustrating frequency versus gain of an electronic device, in accordance with some embodiments of the present disclosure.

FIG. 8 is a graph illustrating frequency versus return loss of an electronic device, in accordance with some embodiments of the present disclosure.

FIG. 9 is a graph illustrating frequency versus gain of an electronic device, in accordance with some embodiments of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

The following disclosure provides different embodiments, or examples, for implementing different features of the provided subject matter. Specific examples of components and embodiments are recited herein. These are, of course, merely examples and are not intended to be limiting. In the present disclosure, reference to the formation of a first feature over or on a second feature in the description that follows may include embodiments in which the first and second features are formed in direct contact, and may also include embodiments in which additional features may be formed between the first and second features, such that the first and second features may not be in direct contact. The present disclosure may repeat reference numerals and/or letters in the various examples. This repetition is for simplicity and clarity and does not in itself dictate a relationship between the various embodiments and/or configurations discussed.

Embodiments of the present disclosure are discussed in detail as follows. It should be appreciated, however, that the present disclosure provides many applicable concepts that can be embodied in a wide variety of specific contexts. The specific embodiments discussed are merely illustrative and do not limit the scope of the disclosure.

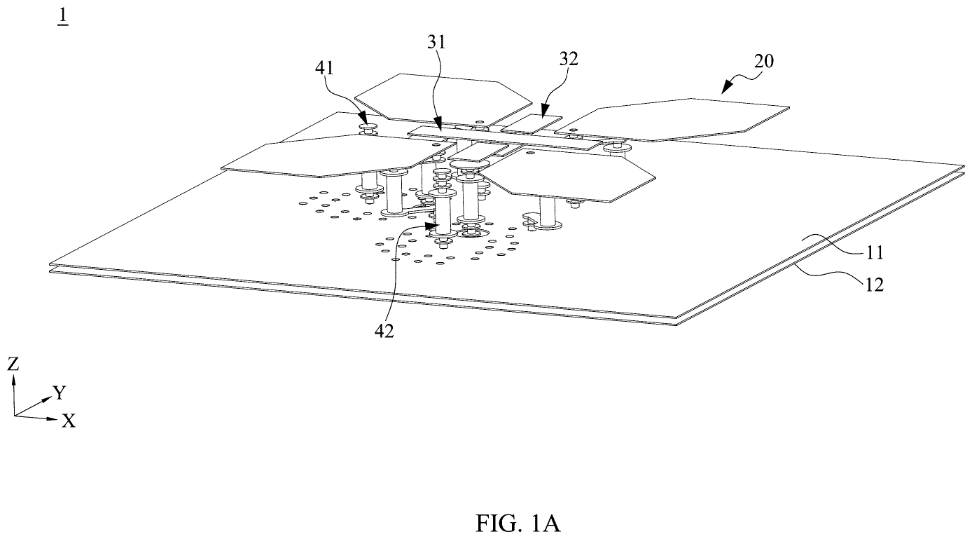

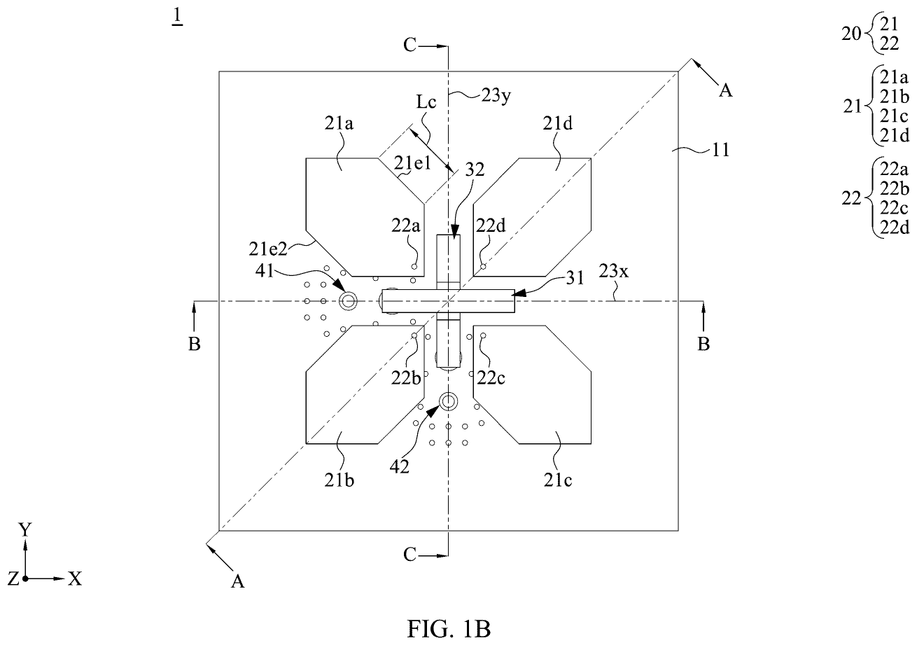

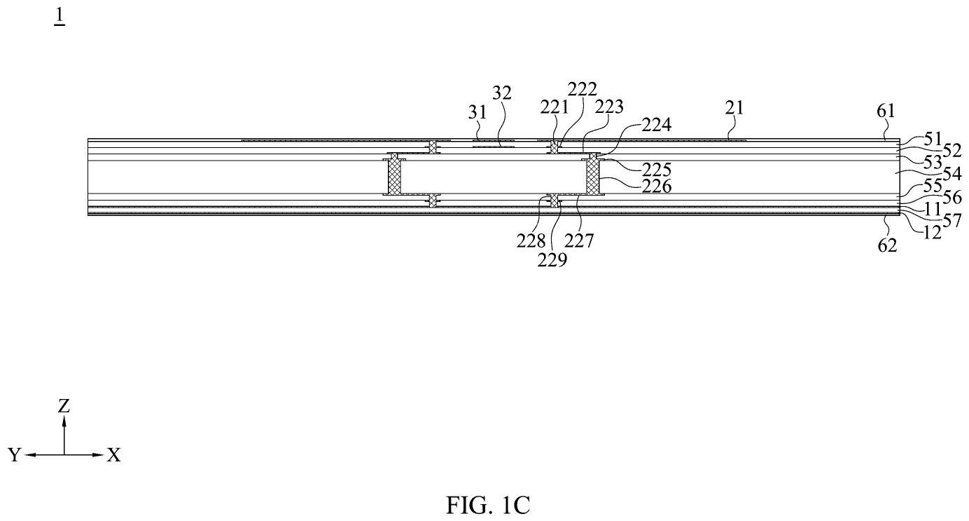

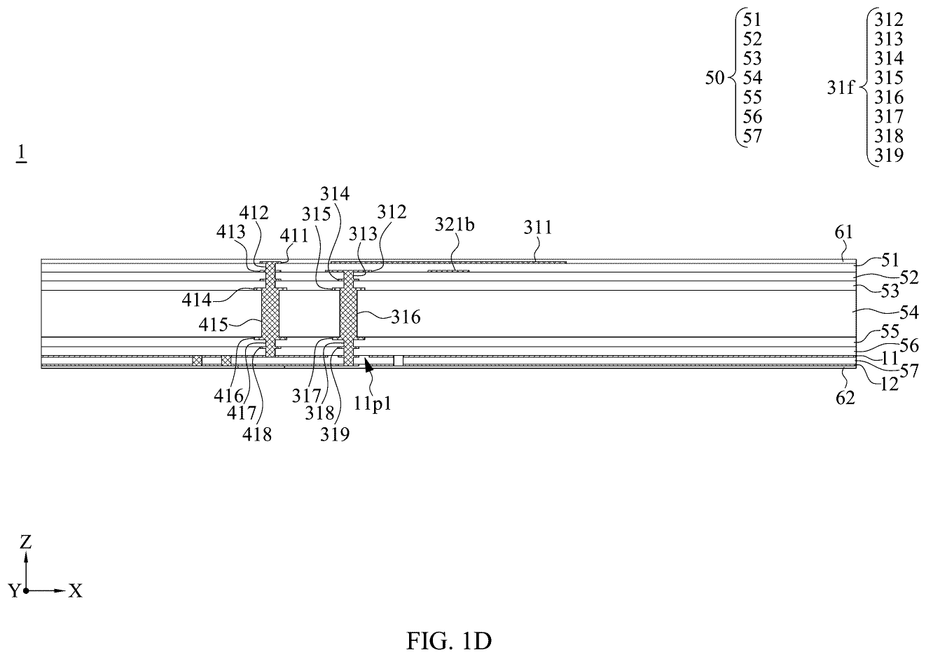

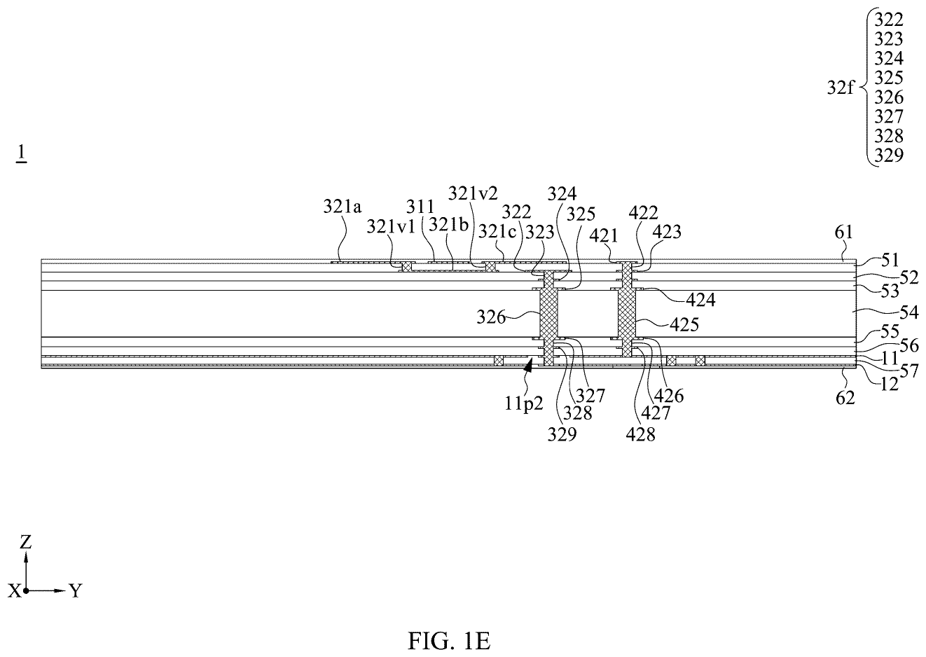

FIG. 1A is a schematic diagram of an electronic device 1, in accordance with some embodiments of the present disclosure. FIG. 1B is a top view of an electronic device 1, in accordance with some embodiments of the present disclosure. FIG. 1C is a cross-section of an electronic device 1 along line A-A of FIG. 1B, in accordance with some embodiments of the present disclosure. FIG. 1D is a cross-section of an electronic device 1 along line B-B of FIG. 1B, in accordance with some embodiments of the present disclosure. FIG. 1E is a cross-section of an electronic device 1 along line C-C of FIG. 1B, in accordance with some embodiments of the present disclosure.

The electronic device 1 may include two conductive layers 11 and 12, an antenna 20, two feeding elements 31 and 32, two conductive columns (or shorting pins) 41 and 42, one or more dielectric layers 50, and two protection layers 61 and 62. For clarity, FIGS. 1A and 1B omit the dielectric layers 50 and protection layers 61 and 62.

The electronic device 1 may be or include antenna in package (AiP) or the like. In some embodiments, the electronic device 1 may be applicable to 5G technology. The electronic device 1 may operate under multiple bandwidths, such as Frequency Range 2 (FR2). For example, the electronic device 1 may operate under the bandwidths of 24.25 to 29.5 GHz and 37 to 43.5 GHz.

Embodiments of the present disclosure discuss an electronic device including cutting corner of electric dipole antenna (patch antenna), shorting pins, folded magnetic dipole antenna, and L-shape capacitive feeding elements. Cutting corner design of the electrical dipole antenna can have better performance at higher frequencies. Shorting pins adjacent to the ports (feeding) of the antenna can modify the direction of the electrical field of the antenna, such that the antenna operates in a fundamental mode and thus enhance gain. The folded magnetic dipole antenna can provide a horizontal current path to reduce the vertical current path, thereby reducing the thickness of the entire package.

Furthermore, the L-shaped feeding elements with capacitive feeding can produce additional capacitance to eliminate existing inductance (such as parasitic inductance), so as to improve the impedance matching of the antenna. Accordingly, the disclosed electronic device can achieve better performance, thin thickness and covering specific high frequency bandwidths.

The conductive layer 11 is disposed on the conductive layer 12. The conductive layer 11 may be spaced apart from the conductive layer 12 by a distance. One of the conductive layers 11 and 12 may be a ground layer, and the other one may be interconnection layer for connecting to other components (such as driver circuit, RFIC, or the like). For example, the conductive layer 11 may be a ground layer and the conductive layer 12 may be the interconnection layer. In some embodiments, the conductive layers 11 and 12 may include patterns for connection. For example, the antenna 20 and the conductive columns 41 and 42 may be connected to the conductive layer 11. In some embodiments, the conductive layer 11 may have one or more openings, such that the feeding elements 31 and 32 may pass through the openings of the conductive layer 11 to connect the conductive layer 12. That is, the feeding elements 31 and 32 is free from contacting the conductive layer 11. In some embodiments, the conductive layers 11 and 12 may be supported by the dielectric layers 50 (see FIGS. 1C to 1E).

In some embodiments, the conductive layers 11 and 12 may include a conductive material such as a metal or metal alloy. Examples of the conductive material include aluminum (Al), copper (Cu), tin (Sn), gold (Au), silver (Ag), nickel (Ni), or an alloy thereof.

In some embodiments, the antenna 20 may be disposed on and connected to the conductive layer 11. The antenna 20 may be a dual polarized antenna. The antenna 20 may be a magneto-electric (ME) dipole antenna. The antenna 20 may be configured to be exited/activated by the feeding elements 31 and 32 to radiate signals in different directions. In some embodiments, the feeding elements 31 and 32 may be a first port and a second port of the antenna 20, respectively. Referring to FIGS. 1B and 1C, the antenna 20 may include an electric dipole 21 and a magnetic dipole 22.

Referring to FIG. 1B, the electric dipole 21 includes four patches 21a, 21b, 21c, and 21d. Each of the patches 21a, 21b, 21c, and 21d is spaced apart from others. The patches 21a, 21b, 21c, and 21d are distributed evenly about a center axis of the antenna 20. The patches 21a and 21b of the antenna 20 are disposed on opposite sides of the feeding element 31 and symmetrical about the feeding element 31. The patches 21c and 21d of the antenna 20 are disposed on opposite sides of the feeding element 31 and symmetrical about the feeding element 31. The patches 21a and 21d of the antenna 20 are disposed on opposite sides of the feeding element 32 and symmetrical about the feeding element 32. The patches 21b and 21c of the antenna 20 are disposed on opposite sides of the feeding element 32 and symmetrical about the feeding element 32. In some embodiments, an edge of the patches 21a, 21b, 21c, and 21d may be substantially parallel to the feeding element 31. An edge of the patches 21a, 21b, 21c, and 21d may be substantially parallel to the feeding element 32. In some embodiments, the patches 21a, 21b, 21c, and 21d may be substantially coplanar with the feeding element 31.

In some embodiments, patches 21a, 21b, 21c, and 21d may be hexagonal, such that an impedance of the antenna 20 can be adjusted. The hexagonal shape of the patches 21a, 21b, 21c, and 21d may be defined by a square with cutting corners (for example, cutting two corners of square), whereby each of the patches 21a, 21b, 21c, and 21d has two cutting edges 21e1 and 21e2 that form an angle of 45 degrees with the X-axis. In some embodiments, a length Lc of the cutting edges 21e1 and 21e2 of the patches 21a, 21b, 21c, and 21d may be determined by design. In some embodiments, the patches 21a, 21b, 21c, and 21d may include a conductive material such as a metal or metal alloy. Examples of the conductive material include aluminum (Al), copper (Cu), tin (Sn), gold (Au), silver (Ag), nickel (Ni), or an alloy thereof.

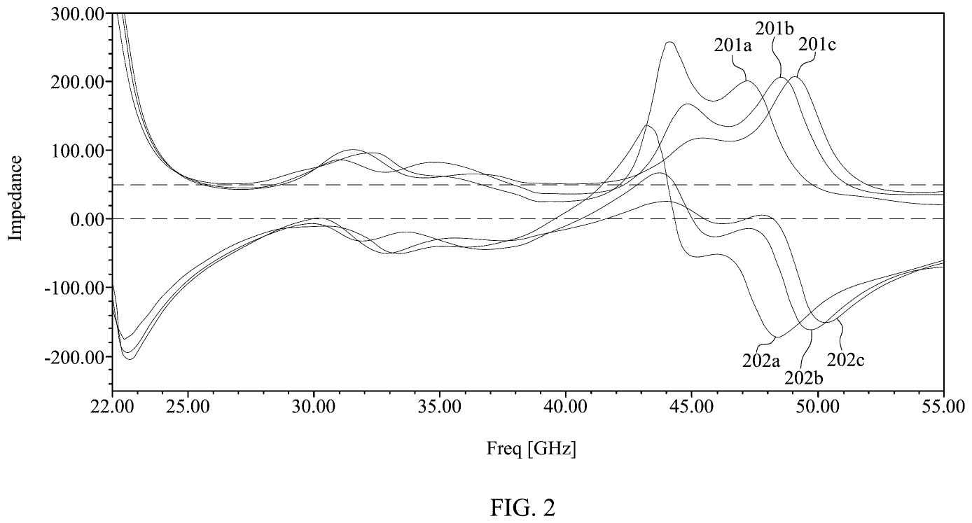

FIG. 2 is a graph illustrating frequency versus impedance of an electronic device 1, in accordance with some embodiments of the present disclosure. Referring to FIG. 2, the x-axis represents the frequency of signals in gigahertz (GHz), and the y-axis represents the impedance of the electronic device 1. FIG. 2 includes six lines 201a, 201b, 201c, 202a, 202b, and 202c. The line 201a represents the real part of impedance of the electronic device 1 with no cutting corners (i.e., the electric dipole 21 having square patches). The line 201b represents the real part of impedance of the electronic device 1 with the cutting length Lc of 0.71 mm (i.e., the electric dipole 21 having hexagonal patches). The line 201c represents the real part of impedance of the electronic device 1 with the cutting length Lc of 0.99 mm (i.e., the electric dipole 21 having hexagonal patches). The line 202a represents the imaginary part of impedance of the electronic device 1 with no cutting corners (i.e., the electric dipole 21 having square patches). The line 202b represents the imaginary part of impedance of the electronic device 1 with the cutting length Lc of 0.71 mm (i.e., the electric dipole 21 having hexagonal patches). The line 202c represents the imaginary part of impedance of the electronic device 1 with the cutting length Lc of 0.99 mm (i.e., the electric dipole 21 having hexagonal patches).

Referring to FIG. 2, the frequency at which the peak of the line 201b occurs is greater than the frequency at which the peak of the line 201a, and the frequency at which the peak of the line 201c occurs is greater than the frequency at which the peak of the line 201b. That is, the impedance of the electronic device 1 can be lower due to the cutting corner. Thus, the electronic device 1 can have better performance at the higher frequency.

Referring back to FIGS. 1A, 1B, and 1C, the magnetic dipole 22 can connect the electrical dipole 21 to the conductive layer 11, i.e., the ground. The magnetic dipole 22 may be disposed between the electrical dipole 21 and the conductive layer 11. In some embodiments, the magnetic dipole 22 may be connected to the electrical dipole 21 adjacent to a corner of the patch. The magnetic dipole 22 may include a folded structure. Referring to FIG. 1B, the magnetic dipole 22 may include four units 22a, 22b, 22c, and 22d, corresponding to the patches 21a, 21b 21c, and 21d of the electrical dipole 21. The magnetic dipole 22 may operate in pairs.

Referring to FIG. 1C, the magnetic dipole 22 may include pillars 221, 224, 226, and 228, and pads 222, 225, and 229, and traces 223 and 227. The trace 223 may be disposed on the conductive layer 11. The trace 223 may be disposed under the electrical dipole 21. The trace 223 may extend horizontally along the X-Y plane (i.e., orthogonal to the Z-axis). In some embodiments, the trace 223 may extend in a direction parallel to the cutting edges 21e1 and 21e2 of the patches 21a, 21b, 21c, and 21d. That is, the extending direction of the trace 223 may form an angle of 45 degrees with the X-axis. In some embodiments, the trace 223 may be connected to the electrical dipole 21 through one or more pillars 221 and one or more pads 222. The pillars 221 may extend vertically to connect the electrical dipole 21 to the pad 222. In some embodiments, a width of the pads 222 may be greater than that of the pillars 221. The number of the pillars 221 and pads 222 is not limited.

In some embodiments, the pillar 226 may be disposed under the trace 223. The size of the pillar 226 may be greater than that of the pillars 221, 224, and 228. For example, the length, width, or diameter of the pillar 226 may be greater than that of the pillars 221, 224, and 228. The pillar 226 may extend vertically to connect the trace 223 to the trace 227. The pillar 226 may be connected to the trace 223 through the pillar 224 and the pad 225. In some embodiments, the vertical length of the pillar 226 may be about 400 micrometer (μm). In some embodiments, the pillar 224 may be substantially identical to the pillars 221. The pad 225 may be similar to the pad 222 but of different size. For example, the size (thickness, width, or diameter) of the pad 225 may be greater than that of the pad 222.

The trace 227 may be disposed between the pillar 226 and the conductive layer 11. Similar to the trace 223, the trace 227 may extend horizontally along the X-Y plane (i.e., orthogonal to the Z-axis). In some embodiments, a length of the trace 227 may be substantially identical to that of the trace 223. The trace 223 may be substantially aligned with the trace 227. The trace 227 may be connected to the pillar 226 directly. In some embodiments, the trace 227 may be connected to the conductive layer 11 through one or more pillars 228 and one or more pads 229. The pillars 228 may be substantially identical to the pillars 221. In some embodiments, the pillars 228 may be substantially aligned with the pillars 221. The pads 229 may be substantially identical to the pads 222. The number of the pillars 228 and pads 229 is not limited.

In some embodiments, the thickness of the trace 223 and pads 222 and 229 may be substantially the same. The thickness of the trace 223 and pads 222 and 229 may be about 15 micrometer (μm). In some embodiments, the thickness of the pad 225 and trace 227 may be substantially the same. The thickness of the pad 225 and trace 227 may be about 22 micrometer (μm). In some embodiments, the pillars 221, 224, 226, and 228 may be vias or other conductive connectors. The pillars 221, 224, 226, and 228, and pads 222, 225, and 229, and traces 223 and 227 may include a conductive material such as a metal or metal alloy. Examples of the conductive material include aluminum (Al), copper (Cu), tin (Sn), gold (Au), silver (Ag), nickel (Ni), or an alloy thereof.

In some embodiments, the magnetic dipole 22 may include one or more vertical portions (such as the pillar 221, 226, and 228) extending along the Z-axis and one or more horizontal portions (such as the traces 223 and 227) extending along the X-Y plane (i.e., orthogonal to the Z-axis). The vertical portions (the pillar 221, 226, and 228) and the horizontal portions (the traces 223 and 227) are alternately arranged and connected. The horizontal portions of the magnetic dipole 22 partially non-overlaps the vertical portions of the magnetic dipole 22 vertically. That is, the traces 223 and 227 have a portion non-overlapping the pillars 221, 226, and 228 vertically. A total length of the magnetic dipole 22 may be substantially identical to one fourth of a working wavelength (operating wavelength) of the antenna 20. The total length of the magnetic dipole 22 may be a sum of the vertical distance of the pillars 221, 224, 226, and 228 and pads 222, 225, and 229 and the horizontal distance of the traces 223 and 227. As the magnetic dipole 22 is operated in pairs, the total length of the pair of magnetic dipoles 22 may be one half of the operating wavelength, which is suitable to radiate signals.

The folded magnetic dipole antenna 22 can provide horizontal current path to reduce the vertical current path. Therefore, the thickness of the entire electronic device 1 can be reduced with the same function.

In some embodiments, the dielectric layers 50 may cover or encapsulate the antenna 20, the feeding elements 31 and 32, and the conductive columns 41 and 42. The dielectric layers 50 includes one or more dielectric layers 51, 52, 53, 54, 55, 56, and 57 stacked on one another. In some embodiments, the protection layer 61 may be disposed on the dielectric layer 51. The protection layer 62 may be disposed below the dielectric layer 57. The protection layer 62 may cover the conductive layer 12.

The electrical dipole 21 (patches) may be disposed on the dielectric layer 51 and covered by the protection layer 61. The magnetic dipole 22 may penetrate one or more of the dielectric layers 50. For example, the magnetic dipole 22 may penetrate the dielectric layers 51 to 56 and connect to the conductive layer 11. In some embodiments, the pad 222 may be disposed on the dielectric layer 52 and covered by the dielectric layer 51. The trace 223 may be disposed on the dielectric layer 53 and covered by the dielectric layer 52. The pillars 221 may penetrate the dielectric layers 51 and 52. The pillars 224 may penetrate the dielectric layer 53. The pad 225 may be disposed on the dielectric layer 54 and covered by the dielectric layer 53. In some embodiments, the pillar 226 of the magnetic dipole 22 may penetrate the dielectric layer 54. The trace 227 may be disposed below the dielectric layer 54 and covered by the dielectric layer 55. The pad 229 may be disposed below the dielectric layer 55 and covered by the dielectric layer 56. The pillars 228 may penetrate the dielectric layers 55 and 56 and connect the conductive layer 11. The dielectric layer 57 may be disposed between the conductive layers 11 and 12.

In some embodiments, the thickness of the dielectric layers 51, 52, 53, 55, 56, and 57 may be substantially the same. The thickness of the dielectric layers 51, 52, 53, 55, 56, and 57 may be about 60 micrometer (μm). The dielectric layer 54 may be thicker than other dielectric layers 51, 52, 53, 55, 56, and 57. For example, the thickness of the dielectric layer 54 may be about 400 micrometer (μm). In some embodiments, the dielectric constant (Dk) of the dielectric layers 50 may be about 3.4. The dielectric layers 50 (including the dielectric layers 51, 52, 53, 54, 55, 56, and 57) may include an organic material, such as polypropylene glycol (PPG). In some embodiments, the thickness of the protection layers 61 and 62 may be about 20 micrometer (μm). In some embodiments, the protection layers 61 and 62 may include a material substantially identical to the dielectric layers 50. In other embodiments, the protection layers 61 and 62 may include a material different from the dielectric layer 50. For example, the protection layers 61 and 62 may be solder masks, such as epoxy or similar material. In some embodiments, the total thickness of the electrical device 1 may be about 0.934 mm.

Referring to FIGS. 1A and 1B, the feeding elements 31 and 32 may be disposed between the patches of the antenna 20. The feeding elements 31 and 32 may electrically couple to the antenna 20. The feeding element 31 may extend along X-axis and be electrically coupled to and feed signals to the antenna 20 along the Y-axis, such that the antenna 20 can be configured to radiate signals. The feeding element 32 may extend along Y-axis and be electrically coupled to and feed signals to the antenna 20 along the X-axis, such that the antenna 20 can be configured to radiate signals. That is, the feeding element 31 may be the first port of the antenna 20 and the feeding element 32 may be the second port of the antenna 20. In some embodiments, the feeding element 32 may be across the feeding element 31. The feeding elements 31 and 32 may passes through the center of the antenna 20. The feeding element 31 may be substantially aligned with the conductive column 41 in the X-axis. The feeding element 32 may extend along the Y-axis and be substantially aligned with the conductive column 42.

In some embodiments, the feeding element 31 may include a conductive plate 311 and a conductive element 31f. The conductive plate 311 may be rectangular in the top view. Referring to FIG. 1D, the conductive plate 311 may extend along the X direction. The conductive plate 311 may be disposed on the dielectric layer 51 and covered by the protection layer 61. The conductive element 31f extends along the Z direction and be coupled to the conductive plate 311. The conductive element 31f is below and separated from the conductive plate 311. In some embodiments, the conductive plate 311 may have a first end (such as the left end) and a second end (such as the right end) opposite to the first end, and the conductive element 31f is close to the first end and far away the second end. The conductive element 31f is capacitively coupled to the conductive plate 311. In another embodiment, the conductive element 31f may be directly connected to the conductive plate 311 through conductive vias (not shown). The conductive element 31f may be substantially parallel to the conductive column 41. The conductive plate 311 of the feeding element 31 and the pad 411 of the conductive column 41 (an end of the conductive column 41) may be substantially at the same elevation. The conductive element 31f may be connected to the conductive layer 12. In some embodiments, the conductive element 31f may penetrate an opening 11p1 of the conductive layer 11 and contact the conductive layer 12. That is, the conductive element 31f may be free from contacting the conductive layer 11. In some embodiments, the conductive element 31f may be electrically connected to other components (not shown), such as driver circuit, RFIC, or the like through the conductive layer 12.

The conductive element 31f may include pillars 313, 316, and 318 and pads 312, 314, 315, 317, and 319. The pad 312 is disposed below the conductive plate 311. The pad 312 may be disposed on the dielectric layer 52 and covered by the dielectric layer 51. The pad 312 is disposed on the pad 314. The pad 314 may be disposed on the pad 315. The pad 314 may be disposed on the dielectric layer 53 and covered by the dielectric layer 52. The pad 314 may be disposed between the pads 312 and 315. The pad 314 may be connected to the pads 312 and 315 through the pillars 313. The pillars 313 may penetrate the dielectric layers 52 and 53. The pad 312 may be close to the conductive plate 311 than the pad 314 is. The area of the pad 312 may be different from that of the pad 314. For example, the area of the pad 312 is greater than that of the pad 314. The area of the pad 312 may be different from that of the pad 315. For example, the area of the pad 312 is greater than that of the pad 315. In some embodiments, the area of the pad 315 is greater than that of the pad 314.

In some embodiments, the pillar 316 may be disposed under the pad 315. The size of the pillar 316 may be greater than that of the pillars 313 and 318. For example, the length, width, or diameter of the pillar 316 may be greater than that of the pillars 313 and 318. The pillar 316 may penetrate the dielectric layer 54. The pillar 316 may be between the pads 315 and 317. The pillar 316 may extend vertically to connect the pad 315 to the pad 317. In some embodiments, the vertical length of the pillar 316 may be about 400 micrometer (μm). The pad 315 may be disposed on the dielectric layer 54 and covered by the dielectric layer 53. The pad 317 may be disposed below the dielectric layer 54 and covered by the dielectric layer 55. The pads 315 and 317 may be similar to the pad 314 but of different size. For example, the size (thickness, width, or diameter) of the pads 315 and 317 may be greater than that of the pad 314.

The pad 317 may be connected to the conductive layer 12 through one or more pillars 318 and one or more pads 319. The pads 319 may be disposed below the dielectric layer 55 and covered by the dielectric layer 56. The pads 319 may be disposed below the dielectric layer 56 and covered by the dielectric layer 57. The pillars 318 may extend vertically. The pillars 318 may penetrate the dielectric layers 55, 56, and 57 to connect to the conductive layer 12. In some embodiments, a width of the pads 319 may be greater than that of the pillars 318. The number of the pillars 318 and pads 319 is not limited.

In some embodiments, the thickness of the conductive plate 311 and pads 312, 314, and 319 may be substantially the same. The thickness of the conductive plate 311 and pads 312, 314, and 319 may be about 15 micrometer (μm). In some embodiments, the thickness of the pads 315 and 317 may be substantially the same. The thickness of the pads 315 and 317 may be about 22 micrometer (μm). In some embodiments, the pillars 313, 316, and 318 may be vias or other conductive connectors. The conductive plate 311, pillars 313, 316, and 318 and pads 312, 314, 315, 317, and 319 may include a conductive material such as a metal or metal alloy. Examples of the conductive material include aluminum (Al), copper (Cu), tin (Sn), gold (Au), silver (Ag), nickel (Ni), or an alloy thereof.

Referring to FIG. 1E, the feeding element 32 may include conductive plates 321a, 321b, and 321c, and a conductive element 32f. The conductive plates 321a and 321c may be disposed on the dielectric layer 51 and covered by the protection layer 61. The conductive plate 321b may be disposed on the dielectric layer 52 and covered by the dielectric layer 51. The conductive plate 321b may be disposed below the conductive plates 321a and 321c. The conductive plate 321b may be connected to the conductive plate 321a through a pillar 321v1. The conductive plate 321b may be connected to the conductive plate 321c through a pillar 321v2. The pillars 321v1 and 321v2 may penetrate the dielectric layer 51. The conductive plate 321a may be substantially coplanar with the conductive plate 321c. In some embodiments, a length of the conductive plate 321a in Y direction may be substantially identical to a length of the conductive plate 321c. The conductive plates 321a, 321b, and 321c may be rectangular in the top view. In some embodiments, the conductive plates 321a, 321b, and 321c may extend along the Y direction. In some embodiments, the conductive plate 311 of the feeding element 31 may be disposed on and vertically overlap the conductive plate 321b of the feeding element 32. In some embodiments, the conductive plate 311 of the feeding element 31 may be substantially aligned with the conductive plates 321a and 321c of the feeding element 32.

The conductive element 32f extends along the Z-axis and be coupled to the conductive plate 321c. The conductive element 32f is below and separated from the conductive plate 321c. In some embodiments, the conductive plate 321c may have a first end (such as the right end) and a second end (such as the left end) opposite to the first end, and the conductive element 32f is close to the first end and far away the second end. The conductive element 32f is disposed below and close to the conductive plate 321c and far away the conductive plate 321a. The conductive element 32f is capacitively coupled to the conductive plate 321c. In another embodiment, the conductive element 32f may be directly connected to the conductive plate 321 through conductive vias (not shown). The conductive element 32f may be substantially parallel to the conductive column 42. The conductive plates 321a and 321c of the feeding element 32 and the pad 421 of the conductive column 42 (an end of the conductive column 42) may be substantially at the same elevation. The conductive element 32f may be connected to the conductive layer 12. In some embodiments, the conductive element 32f may penetrate an opening 11p2 of the conductive layer 11 and contact the conductive layer 12. That is, the conductive element 32f may be free from contacting the conductive layer 11. In some embodiments, the conductive element 32f may be electrically connected to other components (not shown), such as driver circuit, RFIC, or the like through the conductive layer 12.

The conductive element 32f may include pillars 323, 326, and 328 and pads 322, 324, 325, 327, and 329. The pad 322 is disposed below the conductive plate 321c. The pad 322 may be disposed on the dielectric layer 52 and covered by the dielectric layer 51. The pad 322 is disposed on the pad 324. The pad 324 may be disposed on the pad 325. The pad 324 may be disposed between the pads 322 and 325. The pad 324 may be disposed on the dielectric layer 53 and covered by the dielectric layer 52. The pad 324 may be connected to the pads 322 and 325 through the pillars 323. The pillars 323 may penetrate the dielectric layers 52 and 53. The pad 322 may be close to the conductive plate 321c than the pad 324 is. The area of the pad 322 may be different from that of the pad 324. For example, the area of the pad 322 is greater than that of the pad 324. The area of the pad 322 may be different from that of the pad 325. For example, the area of the pad 322 is greater than that of the pad 325. In some embodiments, the area of the pad 325 is greater than that of the pad 324.

In some embodiments, the pillar 326 may be disposed under the pad 325. The pillars 326 may penetrate the dielectric layer 54. The size of the pillar 326 may be greater than that of the pillars 323 and 328. For example, the length, width, or diameter of the pillar 326 may be greater than that of the pillars 323 and 328. The pillar 326 may be between the pads 325 and 327. The pillar 326 may extend vertically to connect the pad 325 to the pad 327. In some embodiments, the vertical length of the pillar 326 may be about 400 micrometer (μm). The pad 325 may be disposed on the dielectric layer 54 and covered by the dielectric layer 53. The pad 327 may be disposed below the dielectric layer 54 and covered by the dielectric layer 55. The pads 325 and 327 may be similar to the pad 324 but of different size. For example, the size (thickness, width, or diameter) of the pads 325 and 327 may be greater than that of the pad 324.

The pad 327 may be connected to the conductive layer 12 through one or more pillars 328 and one or more pads 329. The pads 329 may be disposed below the dielectric layer 55 and covered by the dielectric layer 56. The pads 329 may be disposed below the dielectric layer 56 and covered by the dielectric layer 57. The pillars 328 may extend vertically. The pillars 328 may penetrate the dielectric layers 55, 56, and 57 to connect to the conductive layer 12. In some embodiments, a width of the pads 329 may be greater than that of the pillars 328. The number of the pillars 328 and pads 329 is not limited.

In some embodiments, the thickness of the conductive plates 321a, 321b, and 321c and pads 322, 324, and 329 may be substantially the same. The thickness of the conductive plates 321a, 321b, and 321c and pads 322, 324, and 329 may be about 15 micrometer (μm). In some embodiments, the thickness of the pads 325 and 327 may be substantially the same. The thickness of the pads 325 and 327 may be about 22 micrometer (μm). In some embodiments, the pillars 323, 326, 328, 321v1, and 321v2 may be vias or other conductive connectors. The conductive plates 321a, 321ab, and 321c, pillars 323, 326, 328, 321v1, and 321v2, and pads 322, 324, 325, 327, and 329 may include a conductive material such as a metal or metal alloy. Examples of the conductive material include aluminum (Al), copper (Cu), tin (Sn), gold (Au), silver (Ag), nickel (Ni), or an alloy thereof.

The capacitive feeding elements 31 and 32 can increase capacitance to eliminate the existing inductance (such as parasitic inductance), so as to improve the entire impedance matching of the electronic device 1. Accordingly, the electronic device 1 presented in the subject disclosure can improve performance and increase specific high frequency bandwidth coverage.

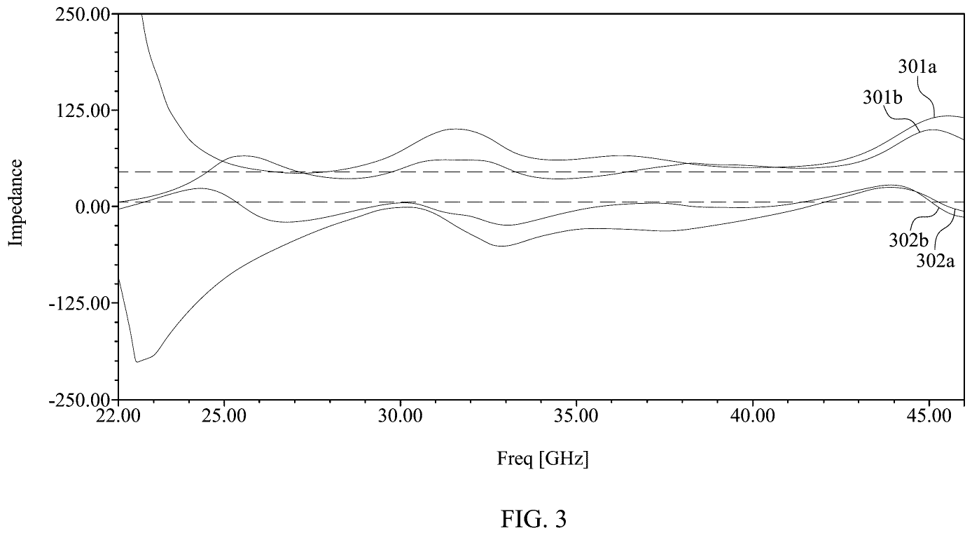

FIG. 3 is a graph illustrating frequency versus impedance of an electronic device 1, in accordance with some embodiments of the present disclosure. Referring to FIG. 3, the x-axis represents the frequency of signals in gigahertz (GHz), and the y-axis represents the impedance of the electronic device 1. FIG. 3 includes four lines 301a, 301b, 302a, and 302b. The line 301a represents the real part of input impedance of the antenna 20 of the electronic device 1 with direct feeding (i.e., the feeding element being directly connected to the driving circuit). The line 302a represents the imaginary part of input impedance of the antenna 20 of the electronic device 1 with direct feeding (i.e., the feeding element being directly connected to the driving circuit). The line 301b represents the real part of input impedance of the antenna 20 of the electronic device 1 with capacitive feeding (i.e., the feeding element being capacitively coupled to the driving circuit). The line 302b represents the imaginary part of input impedance of the antenna 20 of the electronic device 1 with capacitive feeding (i.e., the feeding elements 31 and 32 being capacitively coupled to the driving circuit).

The direct feeding may lead to the high input impedance. Referring to FIG. 3, the input impedance of direct feeding is greater than that of capacitive feeding. In some embodiments, the capacitive feeding may provide additional capacitance to eliminate the parasitic inductance to improve the impedance matching. Accordingly, at some particular frequencies, the line 301b may be about or less than 50 Ohm and the line 302b may approximate 0. Thus, the electronic device 1 can have an improved performance at particular frequencies.

Referring back to FIGS. 1A and 1B, the conductive column 41 may be substantially aligned with the feeding element 31 along the X-axis and configured to connect to the ground, i.e., the conductive layer 11. As the conductive column 41 is connected to the ground, it may be called a shorting pin. In some embodiments, the conductive column 41 may be close to the first end (i.e., the left end) of the conductive plate 311 of FIG. 1D and far away from the second end (i.e., the right end). The conductive column 41 may be adjacent to and spaced apart from the antenna 20. The conductive column 41 may be between the patches 21a and 21b. The patches 21a and 21b may be symmetrical about an imaginary line 23x (along the X-axis) passing through the conductive column 41 and the center axis of the electric dipole 21 (the antenna 20). In some embodiments, the imaginary line 23x may connect the feeding element 31 and the conductive column 41. A distance between the conductive column 41 and the feeding element 31 may be at least one eighth of a working (operating) wavelength of the antenna 20.

The conductive column 41 may be a conductive post, a conductive pillar, or the like. The conductive column 41 may be configured to adjust the electrical field of the antenna 20 to a fundamental mode at a working (operating) wavelength of the antenna 20 to increase the bandwidth and gain thereof. In some embodiments, the conductive column 41 may be configured to adjust a mode of the electrical field of antenna 20 from a higher order mode (such as TM31) to a fundamental mode (such as TM30 or TM10). In some embodiments, the conductive column 41 is configured to adjust a current distribution of the electric dipole 21. In some embodiments, the conductive column 41 may be configured to adjust the electrical field of the antenna 20 when the signals are fed through the feeding element 31 (the first port of the antenna 20).

The conductive column 42 may be substantially aligned with the feeding element 32 in the Y direction and configured to connect to the ground, i.e., the conductive layer 11. As the conductive column 42 is connected to the ground, it may be called a shorting pin. In some embodiments, the conductive column 42 may be close to the first end (i.e., the right end) of the conductive plate 321c of FIG. 1E and far away from the second end (i.e., the left end). The conductive column 42 may be adjacent to and spaced apart from the antenna 20. The conductive column 42 may be between the patches 21b and 21c. The patches 21b and 21c may be symmetrical about an imaginary line 23y (along the Y-axis) passing through the conductive column 42 and the center axis of the electric dipole 21 (the antenna 20). The imaginary line 23y is substantially orthogonal to the imaginary line 23x. In some embodiments, the imaginary line 23y may connect the feeding element 32 and the conductive column 42. A distance between the conductive column 42 and the feeding element 32 may be at least one eighth of a working (operating) wavelength of the antenna 20. The conductive columns 41 and 42 may be a conductive element or a pillar connected to the ground.

The conductive column 42 may be a conductive post, a conductive pillar, or the like. The conductive column 42 may be configured to adjust the electrical field of the antenna 20 to be a fundamental mode at a working (operating) wavelength of the antenna to increase the bandwidth and gain thereof. In some embodiments, the conductive column 42 may be configured to adjust a mode of the electrical field of antenna 20 from a higher order mode (such as TM31) to a fundamental mode (such as TM30 or TM10). In some embodiments, the conductive column 42 is configured to adjust a current distribution of the electric dipole 21. In some embodiments, the conductive column 42 may be configured to adjust the electrical field of the antenna 20 when the signals are fed through the feeding element 32 (the second port of the antenna 20).

Referring to FIG. 1D, the conductive column 41 may include pads 411, 413, 414, 416, and 418, and pillars 412, 415, and 417. The pad 411 may be the top end of the conductive column 41, and the other end of the conductive column is connected to the conductive layer 11. The pad 411 may be substantially aligned with the conductive plate 311 of the feeding element 31. The pad 411 may be disposed on the dielectric layer 51 and covered by the protection layer 61. That is, the pad 411 and the conductive plate 311 may be in the same layer. The pad 414 is disposed below the pad 411. The pad 414 may be disposed on the dielectric layer 54 and covered by the dielectric layer 53. The pad 414 may be similar to the pad 411 but of different size. For example, the size (thickness, width, or diameter) of the pad 414 may be greater than that of the pad 411. The pad 414 may be connected to the pad 411 through one or more pillars 412 and one or more pads 413. The pads 413 may be disposed on the dielectric layer 52 and covered by the dielectric layer 51. The pads 413 may be disposed on the dielectric layer 53 and covered by the dielectric layer 52. The pillars 412 may extend vertically. The pillars 412 may penetrate the dielectric layers 51, 52, and 53 to connect to the pad 414. In some embodiments, a width of the pads 413 may be greater than that of the pillars 412. The number of the pillars 412 and pads 413 is not limited. The pads 413 may be substantially identical to the pad 411.

In some embodiments, the pillar 415 may be disposed under the pad 414. The pillar 415 may penetrate the dielectric layer 54. The size of the pillar 415 may be greater than that of the pillars 412 and 417. For example, the length, width, or diameter of the pillar 415 may be greater than that of the pillars 412 and 417. The pillar 415 may be between the pads 414 and 416. The pillar 415 may extend vertically to connect the pad 414 to the pad 416. In some embodiments, the vertical length of the pillar 415 may be about 400 micrometer (μm). The pad 414 may be disposed on the dielectric layer 54 and covered by the dielectric layer 53. The pad 416 may be disposed below the dielectric layer 54 and covered by the dielectric layer 55. The pad 416 may be substantially identical to the pad 414.

The pad 416 may be connected to the conductive layer 11 through one or more pillars 417 and one or more pads 418. The pads 418 may be disposed below the dielectric layer 55 and covered by the dielectric layer 56. The pillars 417 may extend vertically. The pillars 417 may penetrate the dielectric layers 55 and 56 to connect to the conductive layer 11 (i.e., the ground). In some embodiments, a width of the pads 418 may be greater than that of the pillars 417. The number of the pillars 417 and pads 418 is not limited.

In some embodiments, the thickness of the pads 411, 413, and 418 may be substantially the same. The thickness of the pads 411, 413, and 418 may be about 15 micrometer (μm). In some embodiments, the thickness of the pads 414 and 416 may be substantially the same. The thickness of the pads 414 and 416 may be about 22 micrometer (μm). In some embodiments, the pillars 412, 415, and 417 may be vias or other conductive connectors. The pads 411, 413, 414, 416, and 418, and pillars 412, 415, and 417 may include a conductive material such as a metal or metal alloy. Examples of the conductive material include aluminum (Al), copper (Cu), tin (Sn), gold (Au), silver (Ag), nickel (Ni), or an alloy thereof.

Referring to FIG. 1E, the conductive column 42 may include pads 421, 423, 424, 426, and 428, and pillars 422, 425, and 427. The pad 421 may be the top end of the conductive column 42, and the other end of the conductive column is connected to the conductive layer 11. The pad 421 may be substantially aligned with the conductive plates 321a and 321c of the feeding element 32. The pad 421 may be disposed on the dielectric layer 51 and covered by the protection layer 61. That is, the pad 421 and the conductive plates 321a and 321c may be in the same layer. The pad 424 is disposed below the pad 421. The pad 424 may be disposed on the dielectric layer 54 and covered by the dielectric layer 53. The pad 424 may be similar to the pad 421 but of different size. For example, the size (thickness, width, or diameter) of the pad 424 may be greater than that of the pad 421. The pad 424 may be connected to the pad 421 through one or more pillars 422 and one or more pads 423. The pads 423 may be disposed on the dielectric layer 52 and covered by the dielectric layer 51. The pads 423 may be disposed on the dielectric layer 53 and covered by the dielectric layer 52. The pillars 422 may extend vertically. The pillars 422 may penetrate the dielectric layers 51, 52, and 53 to connect to the pad 424. In some embodiments, a width of the pads 423 may be greater than that of the pillars 422. The number of the pillars 422 and pads 423 is not limited. The pads 423 may be substantially identical to the pad 421.

In some embodiments, the pillar 425 may be disposed under the pad 424. The pillar 425 may penetrate the dielectric layer 54. The size of the pillar 425 may be greater than that of the pillars 422 and 427. For example, the length, width, or diameter of the pillar 425 may be greater than that of the pillars 422 and 427. The pillar 425 may be between the pads 424 and 426. The pillar 425 may extend vertically to connect the pad 424 to the pad 426. In some embodiments, the vertical length of the pillar 425 may be about 400 micrometer (μm). The pad 424 may be disposed on the dielectric layer 54 and covered by the dielectric layer 53. The pad 426 may be disposed below the dielectric layer 54 and covered by the dielectric layer 55. The pad 426 may be substantially identical to the pad 424.

The pad 426 may be connected to the conductive layer 11 through one or more pillars 427 and one or more pads 428. The pads 428 may be disposed below the dielectric layer 55 and covered by the dielectric layer 56. The pillars 427 may extend vertically. The pillars 427 may penetrate the dielectric layers 55 and 56 to connect to the conductive layer 11 (i.e., the ground). In some embodiments, a width of the pads 428 may be greater than that of the pillars 427. The number of the pillars 427 and pads 428 is not limited.

In some embodiments, the thickness of the pads 421, 423, and 428 may be substantially the same. The thickness of the pads 421, 423, and 428 may be about 15 micrometer (μm). In some embodiments, the thickness of the pads 424 and 426 may be substantially the same. The thickness of the pads 424 and 426 may be about 22 micrometer (μm). In some embodiments, the pillars 422, 425, and 427 may be vias or other conductive connectors. The pads 421, 423, 424, 426, and 428, and pillars 422, 425, and 427 may include a conductive material such as a metal or metal alloy. Examples of the conductive material include aluminum (Al), copper (Cu), tin (Sn), gold (Au), silver (Ag), nickel (Ni), or an alloy thereof.

The conductive columns 41 and 42 adjacent to the ports (conductive elements 31f and 32f of the feeding elements 31 and 32) of the antenna 20 can modify the direction of the electrical field of the antenna, such that the antenna 20 can operate in a fundamental mode and thus enhance the gain thereof. Accordingly, the radiation efficiency of the antenna 20 may be better by adding the conductive columns 41 and 42, and thus the electronic device 1 can achieve better performance at specific frequency bandwidths.

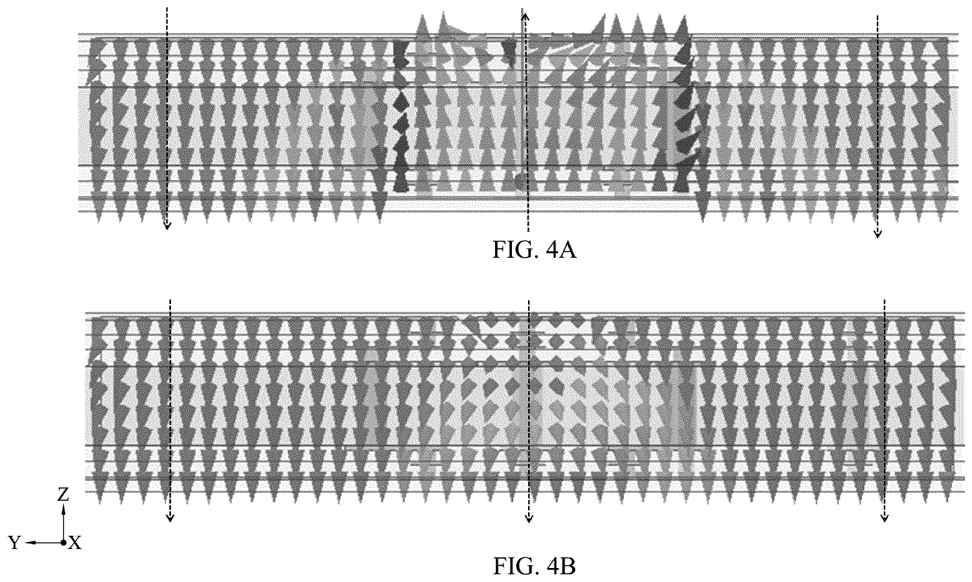

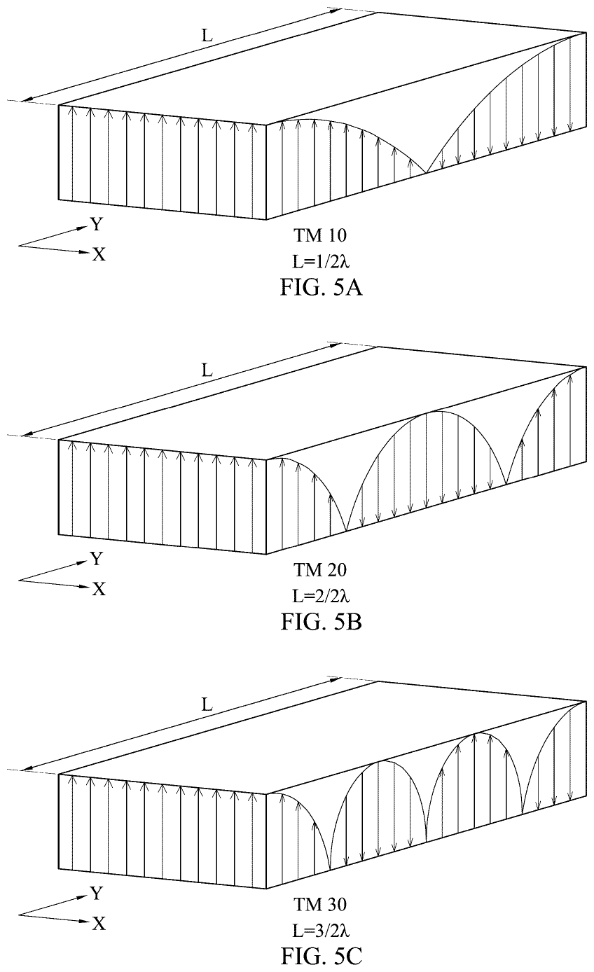

FIG. 4A is a graph illustrating electrical field distribution of an electronic device 1 under a higher order mode, in accordance with some embodiments of the present disclosure. FIG. 4A shows an electrical field distribution of the electronic device 1 without the conductive columns 41 and 42 in the left side view of FIG. 1B. FIG. 4B is a graph illustrating electrical field distribution of an electronic device 1 under a fundamental mode, in accordance with some embodiments of the present disclosure. FIG. 4B shows an electrical field distribution of the electronic device 1 having the conductive columns 41 and 42 in the left side view of FIG. 1B.

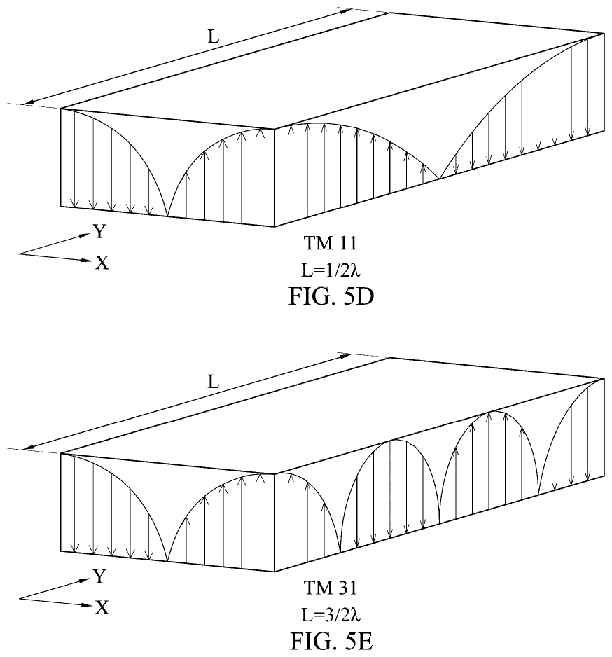

Referring to FIG. 4A, the electrical field at the center of the electrical device 1 may point/extend in multiple directions. In particular, the electrical field at the center may point upward, and the electrical field at the periphery may point downward. FIG. 4A shows the antenna 20 may operate or resonate at a higher order mode, such as TM11 or TM31 mode. Referring to FIG. 4B, the electrical field of the electrical device 1 may basically point/extend in the same direction, i.e., downward. FIG. 4B shows the antenna 20 may operate or resonate at a fundamental mode, such as TM10 or TM30 mode. Referring to FIGS. 4A and 4B, the conductive columns 41 and 42 may be configured to adjust a direction of the electrical field of the antenna 20 under operating. The explanation of the resonance mode of the antenna may be found in FIGS. 5A to 5E.

FIGS. 5A, 5B, 5C, 5D, and 5E are schematic diagrams illustrating an electrical field of an antenna, in accordance with some embodiments of the present disclosure. FIG. 5A shows a patch antenna with a length L along the Y-axis. When the antenna operates at a wavelength λ at length L=1/2λ, the antenna may operate at the fundamental mode of TM10. The electrical field of the patch antenna may point the same direction (upward or downward) along the X-axis with the same amplitude. The patch antenna can form a standing wave along the Y-axis to radiate the same. In some embodiments, the profile of the electrical field of the patch antenna along the Y-axis may be symmetrical to about the middle point at the Y-axis of the patch but in opposite phases. At the middle point of the Y-axis of the patch, the electrical field (or voltage) may be zero. At the two ends of the Y-axis of the patch, the electrical field (or voltage) may reach the respective peak but in opposite phases, thereby facilitating the radiation of the electromagnetic waves.

Referring to FIG. 5B, at length L=2/2λ, the antenna may operate at the resonance mode of TM20. The electrical field of the patch antenna may be the same direction along the X-axis. The electrical field of the patch antenna along the Y-axis may eliminate each other, and thus the patch antenna at TM20 cannot radiate signals.

Referring to FIG. 5C, in some cases, at length L=3/2λ, the antenna may operate at the fundamental mode of TM30. The electrical field of the patch antenna may point the same direction (upward or downward) along the X-axis with the same amplitude. The patch antenna can form a standing wave along the Y-axis to radiate the same. In some embodiments, the profile of the electrical field of the patch antenna along the Y-axis may be symmetrical to about the middle point at the Y-axis of the patch but in opposite phases. At the middle point of the Y-axis of the patch, the electrical field (or voltage) may be zero. At the two ends of the Y-axis of the patch, the electrical field (or voltage) may reach the respective peak but in opposite phases, thereby facilitating the radiation of the electromagnetic waves.

Referring to FIG. 5D, in some cases, when the antenna operates at a wavelength λ at length L=1/2λ, the antenna may operate at the higher order mode of TM11. The electrical field of the patch antenna may point/extend in opposite directions (upward and downward) along the X-axis. The electrical field of the patch antenna along the X-axis may eliminate each other, and thus the patch antenna at TM11 cannot work.

Referring to FIG. 5E, in some cases, when the antenna operates at a wavelength λ at length L=3/2λ, the antenna may operate at the higher order mode of TM31. The electrical field of the patch antenna may point/extend in the opposite directions (upward and downward) along the X-axis. The electrical field of the patch antenna along the X-axis may eliminate each other, and thus the patch antenna at TM31 cannot work.

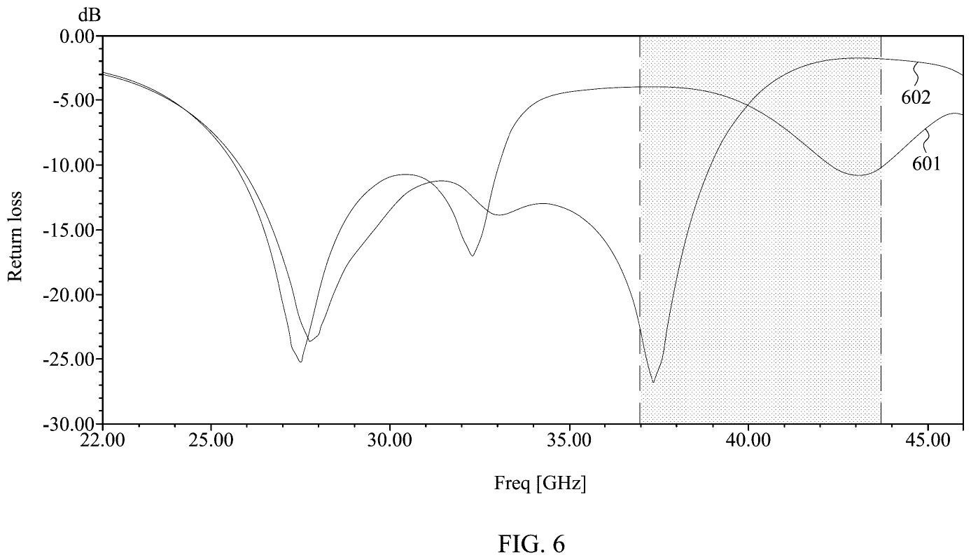

FIG. 6 is a graph illustrating frequency versus return loss of an electronic device 1, in accordance with some embodiments of the present disclosure. Referring to FIG. 6, the x-axis represents the frequency of signals in gigahertz (GHz), and the y-axis represents the return loss of the electronic device 1 (or antenna 20) in dB.

FIG. 6 includes two lines 601 and 602. The line 601 represents the return loss of the electronic device 1 without conductive columns 41 and 42. The line 602 represents the return loss of the electronic device 1 with conductive columns 41 and 42. Adding the conductive columns 41 and 42, the return loss radiated and received by the first port, i.e., the S-parameter (S11), of the electronic device 1 can be reduced to a specific bandwidth. In some embodiments, the line 602 may be lower than the line 601 within the bandwidths of 33 to 39 GHz. In particular, the line 602 may have a value at least less than −10 dB within the bandwidths of 33 to 39 GHz. In some embodiments, the return loss of −10 dB may be a criteria for determining whether the antenna is acceptable. Thus, the electronic device 1 can have an improved performance at particular bandwidth.

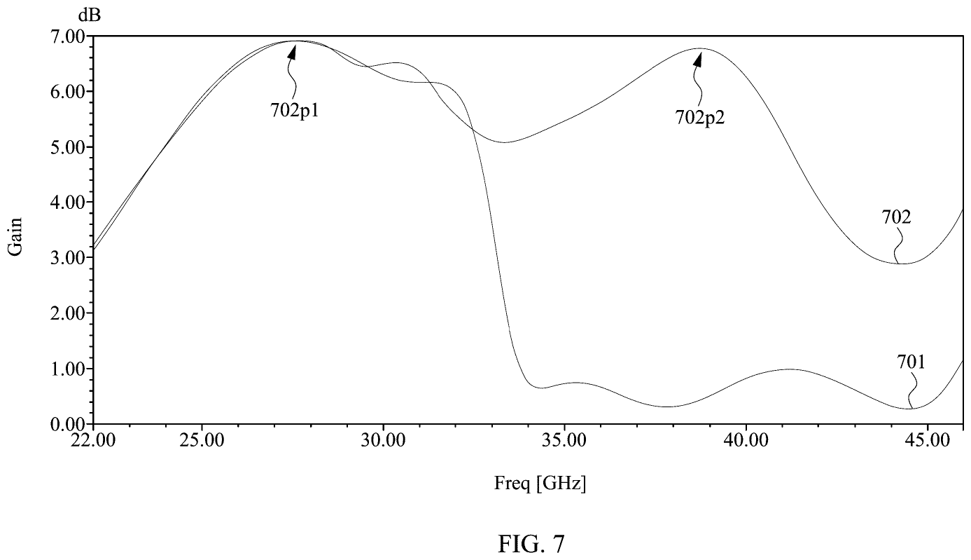

FIG. 7 is a graph illustrating frequency versus gain of an electronic device, in accordance with some embodiments of the present disclosure. Referring to FIG. 7, the x-axis represents the frequency of signals in gigahertz (GHz), and the y-axis represents the gain of the electronic device 1 (or antenna 20) in dB.

FIG. 7 includes two lines 701 and 702. The line 701 represents the gain of the electronic device 1 without conductive columns 41 and 42. The line 702 represents the gain of the electronic device 1 with conductive columns 41 and 42. Adding the conductive columns 41 and 42, the gain of the electronic device 1 can be enhanced in a specific bandwidth. Referring to FIG. 7, the line 702 may include two peaks 702p1 and 702p2. In some embodiments, the peak 702p1 may represent the resonance mode of TM10, and the peak 702p2 may represent the resonance mode of TM30. In some embodiments, the line 702 may be higher than the line 701 at the frequencies greater than 32.5 GHz. In particular, the line 702 may have a value at least greater than 5 dB within the bandwidths of 24 to 41 GHz. In some embodiments, the gain of 5 dB may be a criteria for determining whether the antenna is acceptable. In particular, the antenna 20 of the electronic device 1 may increase gain by adding conductive columns 41 and 42 within the bandwidths of 24 to 41 GHz. Thus, the electronic device 1 can have improved performance at particular bandwidths.

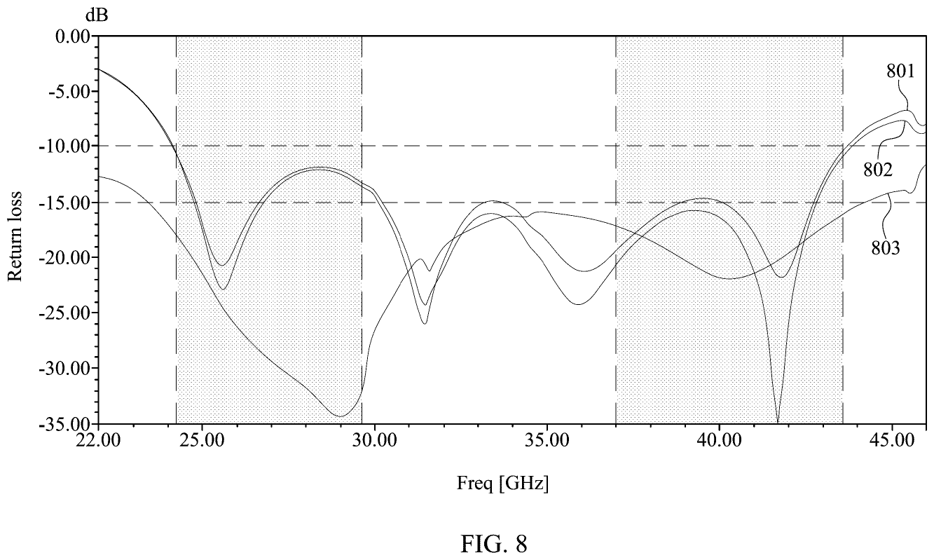

FIG. 8 is a graph illustrating frequency versus return loss of an electronic device 1, in accordance with some embodiments of the present disclosure. Referring to FIG. 8, the x-axis represents the frequency of signals in gigahertz (GHz), and the y-axis represents the return loss of the electronic device 1 (or antenna 20) in dB.

FIG. 8 includes two grey zones indicating the operating bandwidths of 24.25 to 29.5 GHz and 37 to 43.5 GHz, at which the antenna 20 is capable of operation. FIG. 8 includes three lines 801, 802, and 803. The line 801 represents the return loss of the electronic device 1 radiated and received by the first port (the feeding element 31), i.e., the S-parameter (S11). The line 802 represents the return loss of the electronic device 1 radiated and received by the second port (the feeding element 32), i.e., the S-parameter (S22). The line 803 represents the return loss of the electronic device 1 radiated by the first port and received by the second port, i.e., the S-parameter (S21).

In some embodiments, the line 801 (S11 parameter) can be less than −10 dB in the bandwidth of 24.14 to 43.68 GHz. The line 802 (S22 parameter) can be less than −10 dB in the bandwidth of 24.14 to 43.84 GHz. Accordingly, the antenna 20 of electronic device 1 provided in the present disclosure may have S11 and S22 both less than −10 dB, and even less than −15 dB, in the operating bandwidths. In some embodiments, the return loss of −10 dB may be a criteria for determining whether the antenna is acceptable.

The line 803 indicates the isolation (S21 parameter) between two ports of the antenna 20. The line 803 (S21 parameter) can be less than −15 dB in the bandwidth of 23.41 to 44.22 GHz. In some embodiments, the return loss of −15 dB may be a criteria for determining whether the isolation of the dual port antenna is acceptable. Thus, the electronic device 1 can have improved performance at two operating bandwidths.

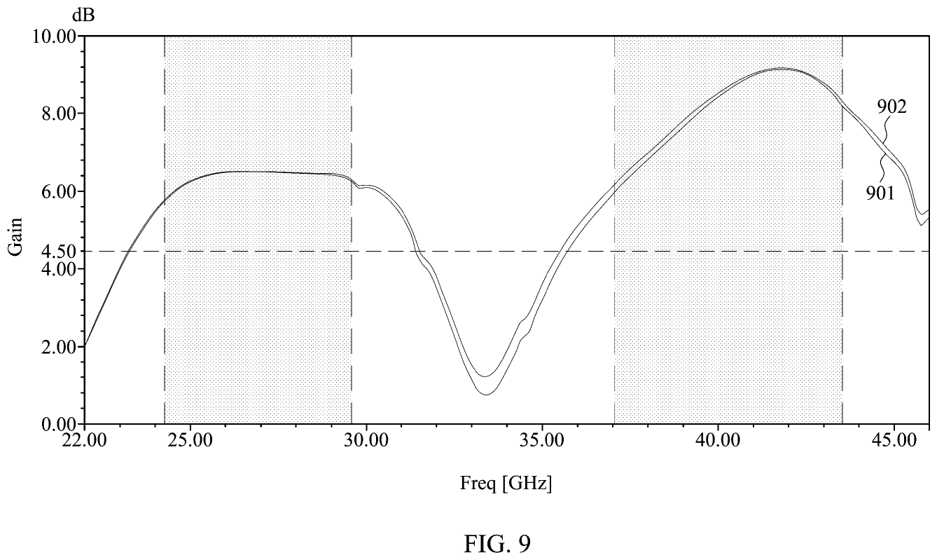

FIG. 9 is a graph illustrating frequency versus gain of an electronic device, in accordance with some embodiments of the present disclosure. Referring to FIG. 9, the x-axis represents the frequency of signals in gigahertz (GHz), and the y-axis represents the gain of the electronic device 1 (or antenna 20) in dB.

FIG. 9 includes two grey zones indicating the operating bandwidths of 24.25 to 29.5 GHz and 37 to 43.5 GHz, at which the antenna 20 is capable of operation. FIG. 9 includes two lines 901 and 902. The line 901 represents the gain of the electronic device 1 radiated by the first port (the feeding element 31). The line 902 represents the gain of the electronic device 1 radiated by the second port (the feeding element 32). The line 901 may match the line 902. That is, the antenna 20 may have the similar performance when activated by two different ports. The gain of the antenna 20 can be enhanced at least in the operating bandwidths.

In some embodiments, the lines 901 and 902 may have a value at least greater than 4.5 dB within the bandwidths of 23.2 to 31.5 GHz and 35.6 to 46 GHz. The lines 901 and 902 may have a value at least greater than 5 dB within the operating bandwidths. In some embodiments, the gain of 5 dB may be a criteria for determining whether the antenna is acceptable. In particular, the antenna 20 of the electronic device 1 may increase gain by including the cutting corner design of the antenna 20, capacitive feeding elements 31 and 32, and conductive columns 41 and 42. Thus, the electronic device 1 can have improved performance at particular bandwidths.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a magneto-electric dipole antenna; and
a first conductive column adjacent to and spaced apart from the magneto-electric dipole antenna, wherein the first conductive column is configured to adjust a mode of the electrical field of the magneto-electric dipole antenna.

2. The electronic device of claim 1, wherein the magneto-electric dipole antenna includes a magnetic dipole antenna and an electric dipole antenna, wherein the first conductive column is configured to connect to the ground and adjust a current distribution of the electric dipole antenna.

3. The electronic device of claim 2, wherein the electric dipole antenna includes:
a first patch;
a second patch spaced apart from the first patch;
wherein the first conductive column is between the first patch and the second patch.

4. The electronic device of claim 3, wherein the first patch and the second patch are symmetrical about a first imaginary line passing through the first conductive column.

5. The electronic device of claim 4, wherein the electric dipole antenna further comprises a third patch, wherein the electronic device further comprises a second conductive column between the second patch and the third patch, and wherein the second patch and the third patch are symmetrical about a second imaginary line, the second imaginary line passing through the second conductive column.

6. The electronic device of claim 5, wherein the second imaginary line is substantially orthogonal to the first imaginary line.

7. The electronic device of claim 2, wherein the magnetic dipole antenna includes:
a first part electrically connected to the electric dipole antenna and extending horizontally in a cross-sectional view;
a second part vertically overlapping the first part and extending horizontally in the cross-sectional view; and
a third part (226) connecting the first part to the second part and extending vertically in the cross-sectional view.

8. The electronic device of claim 7, wherein a width of the first part is substantially identical to a width of the second part in the cross-sectional view.

9. The electronic device of claim 1, wherein the first conductive column is configured to adjust the electrical field of the magneto-electric dipole antenna from a higher order mode to a fundamental mode.

10. The electronic device of claim 1, further comprising a first feeding element electrically coupled to the magneto-electric dipole antenna, wherein the first feeding element extends in a first direction and is substantially aligned with the first conductive column in the first direction.

11. The electronic device of claim 10, wherein the magneto-electric dipole antenna is symmetrical about an imaginary line connecting the first feeding element and the first conductive column.

12. An electronic device, comprising:
an antenna;
a feeding element extending along a first direction and electrically coupled to the antenna, such that the antenna is configured to radiate signals; and
a conductive column substantially aligned with the feeding element in the first direction and connected to the ground.

13. The electronic device of claim 12, wherein the antenna includes a first portion and a second portion disposed on opposite sides of the feeding element and symmetrical about the feeding element.

14. The electronic device of claim 12, wherein the feeding element includes a conductive plate extending along the first direction and a conductive element coupled to the conductive plate.

15. The electronic device of claim 14, wherein the conductive element is below and separated from the conductive plate, whereon the conductive element is capacitively coupled to the conductive plate.

16. The electronic device of claim 14, wherein the conductive plate has a first end and a second end opposite to the first end, wherein the conductive element is disposed below the first end, and the conductive column is close to the first end and far away from the second end.

17. An electronic device, comprising:
a dual polarized antenna;
a first feeding element extending in a first direction;
a second feeding element extending across the first feeding element in a second direction substantially perpendicular to the first direction; and
a first conductive column adjacent to and spaced apart from the first feeding element, the first conductive column configured to adjust a direction of the electrical field of the dual polarized antenna under operating.

18. The electronic device of claim 17, further comprising a second conductive column adjacent to and spaced apart from the second feeding element, wherein a part of the dual polarized antenna is between the first conductive column and the second conductive column.

19. The electronic device of claim 17, wherein the first feeding element is electrically coupled to and feed signals to the dual polarized antenna in the second direction, and wherein the second feeding element is electrically coupled to and feed signals to the dual polarized antenna in the first direction.

20. The electronic device of claim 17, wherein a distance between the first conductive column and the first feeding element is at least one eighth of a working wavelength of the dual polarized antenna.
